(19) United States
(12) Patent Application Publication
(10) Pub. No.: US 2010/0090982 A1
(43) Pub. Date: Apr. 15, 2010

(54) Information processing apparatus, information processing method, information processing system and information processing program

(75) Inventors: Haruo Oba, Kanagawa (JP); Atsushi Koshiyama, Tokyo (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/587,359

(22) Filed: Oct. 6, 2009

(30) Foreign Application Priority Data
Oct. 10, 2008 (JP) P2008-264221

(51) Int. Cl. G06F 3/045

(52) U.S. Cl. 345/174

(57) ABSTRACT

An information processing apparatus includes: sensor means for detecting a distance to a detection target spatially separated therefrom; storage means for storing information on boundary values of a plurality of layers to which different functions are respectively assigned, and which are set according to different distances; determination means for determining in which one of the plurality of layers the detection target is positioned, from the boundary values of the plurality of layers in the storage means and an output signal of the sensor means; and control means for executing a process about the function assigned to that layer where the detection target is positioned, based on a determination result from the determination means.

### BACKGROUND OF THE INVENTION

1. Field of the Invention

The present invention relates to an information processing apparatus, information processing method, information processing system and information processing program that use non-contact type sensor means and selects a function using spatial position information on an object to be detected, such as a human hand or finger to be detected by the sensor means.

2. Description of the Related Art

In the past, a person generally uses an operation button or a touch panel in making some input. A touch panel is combined with a flat display, such as an LCD (Liquid Crystal Display), so that an operational input is made as if button icons or so displayed on the display screen were depressed.

Such an input operation is premised on contacting with or pressing the flat surface of an operation button top or the screen of the touch panel. Accordingly, the limited operation, namely contacting with or pressing the flat surface, is an operational input. In addition, the technique is limited to an application which enables contact with a flat surface.

This has raised problems such that contact- or pressure-oriented vibration or force interferes with the performance of the device, and stains or damages the contact surface.

As an improvement on those problems, a proximity detection information display apparatus is disclosed in Patent Document 1 (JP-A-2008-117371) by the present applicant. Patent Document 1 describes the use of sensor means with a sensor panel which has a plurality of line electrodes or point electrodes arranged in, for example, two orthogonal directions.

The sensor means detects the distance between the sensor panel surface containing a plurality of electrodes and a detection target spatially separated from the panel surface, e.g., a human hand or finger, by detecting a capacitance corresponding to the distance for each of those electrodes.

That is, the capacitance between each of a plurality of electrodes of the sensor panel and the ground changes according to the spatially separated distance between the position of a human hand or finger and the panel surface. In this respect, a threshold value is set for the spatial distance between the position of a human hand or finger and the panel surface, and it is detected if the finger has moved closer to or away from the panel than that distance by detecting a change in capacitance corresponding to the distance.

Patent Document 1 discloses a technique capable of enhancing the sensitivity of detecting the capacitance by changing the interval between electrodes which detect the capacitance according to the distance between the detection target and the sensor panel surface.

According to the preceding technique proposed, a switch input can be made without touching the sensor panel. Because the sensor panel has a plurality of line electrodes or point electrodes arranged in two orthogonal directions, the motion of a hand or a finger in a direction along the panel surface can be detected spatially, bringing about a characteristic such that an operational input according to the motion of the hand or finger within the space can also be made.

### SUMMARY OF THE INVENTION

In the past, there are various configurations for selecting a specific one of a plurality of functions provided in a device. For example, one known configuration is provided with operation buttons in correspondence to the respective functions, so that operating an operation button can allow the corresponding function to be selected. However, this scheme needs operation buttons equal in number to the corresponding functions, which is undesirable for small electronic devices having a small space for providing the operation buttons. In addition, this scheme also needs the aforementioned operation of contacting with or pressing the operation buttons, and thus cannot overcome the aforementioned problem.

There is a scheme of displaying a menu list of a plurality of functions on the display screen, and selecting a desired function to be executed from the list by manipulating a cursor or a touch panel. This scheme needs a troublesome operation of operating a button displayed on the menu and manipulating the cursor button or the touch panel. In addition, this scheme likewise needs the aforementioned operation of contacting with or pressing the operation buttons or the touch panel, and thus cannot overcome the aforementioned problem.

The use of the technique disclosed in Patent Document 1 eliminates the need for operation buttons, which can overcome the problem of contacting with or pressing the operation buttons.

It is therefore desirable to use a scheme of enabling an input operation without contacting with or pressing the operation buttons as disclosed in Patent Document 1, and easily select one of a plurality of functions using the scheme.

According to an embodiment of the present invention, there is provided an information processing apparatus including:
sensor means for detecting a distance to a detection target spatially separated therefrom;
storage means for storing information on boundary values of a plurality of layers to which different functions are respectively assigned, and which are set according to different distances;
determination means for determining in which one of the plurality of layers the detection target is positioned, from the boundary values of the plurality of layers in the storage means and an output signal of the sensor means; and
control means for executing a process about the function assigned to that layer where the detection target is positioned, based on a determination result from the determination means.

In the information processing apparatus according to the embodiment of the invention with the above configuration, a plurality of layers are set according to the spatially separated distance (hereinafter simply referred to as distance) between the sensor means and a detection target detected by the sensor means, and the boundary values of the distances of the individual layers are stored in the storage means. Functions are assigned to the respective layers beforehand.

The determination means determines in which one of the plurality of layers a detection target is positioned, from the boundary values of the plurality of layers stored in the storage means and the output signal of the sensor means. The control means discriminates the function assigned to the determined layer, and performs control on the function.

The following takes place when a human hand or finger is used as a detection target.

When a user changes a spatially separated distance of a hand or finger to the sensor means, the determination means determines the layer where the hand or finger is then positioned. Then, the control means performs a control process on the function assigned to that layer.

Therefore, the user can easily select a desired function by changing a layer where the user's hand or finger is positioned by spatially moving the hand or finger closer to or away from the sensor means.

According to the embodiment of the invention, it is possible to easily select one of a plurality of functions provided in an information processing apparatus without needing an operation of contacting with or processing an operation button or a touch panel.

### BRIEF DESCRIPTION OF THE DRAWINGS

FIG. 1 is a block diagram showing an example of the hardware configuration of an embodiment of an information processing apparatus according to the present invention;

FIG. 2 is a diagram used to explain an example of sensor means to be used in the embodiment of the information processing apparatus according to the invention;

FIG. 3 is a diagram used to explain the example of the sensor means to be used in the embodiment of the information processing apparatus according to the invention;

FIGS. 4A and 4B are diagrams for explaining an example of setting a layer according to a distance to a detection target from the sensor means in the embodiment of the information processing apparatus according to the invention;

FIG. 5 is a diagram for explaining the correlation between layers according to distances to a detection target from the sensor means in the embodiment of the information processing apparatus according to the invention, and functions to be assigned to the layers;

FIG. 6 is a diagram showing a part of a flowchart for explaining an example of the processing operation of the embodiment of the information processing apparatus according to the invention;

FIG. 7 is a diagram showing a part of the flowchart for explaining an example of the processing operation of the embodiment of the information processing apparatus according to the invention;

FIGS. 8A and 8B are diagrams used to explain the embodiment of the information processing apparatus according to the invention;

FIG. 9 is a block diagram showing an example of the hardware configuration of an embodiment of an information processing system according to the invention;

FIG. 10 is a block diagram showing an example of the hardware configuration of the embodiment of the information processing system according to the invention;

FIG. 11 is a diagram for explaining an example of setting a layer according to a distance to a detection target from sensor means in the embodiment of the information processing system according to the invention;

FIG. 12 is a diagram for explaining the correlation between layers according to distances to a detection target from the sensor means in the embodiment of the information processing system according to the invention, and functions to be assigned to the layers;

FIGS. 13A to 13C are diagrams used to explain the embodiment of the information processing system according to the invention;

FIG. 14 is a diagram showing a flowchart for explaining an example of the processing operation of the embodiment of the information processing system according to the invention;

FIG. 15 is a diagram showing a flowchart for explaining an example of the processing operation of the embodiment of the information processing system according to the invention;

FIG. 16 is a diagram showing a flowchart for explaining an example of the processing operation of the embodiment of the information processing system according to the invention; and

FIG. 17 is a diagram showing a flowchart for explaining an example of the processing operation of the embodiment of the information processing system according to the invention.

### DETAILED DESCRIPTION OF THE PREFERRED EMBODIMENTS

Embodiments of an information processing apparatus according to the present invention will be described below with reference to the accompanying drawings. In the embodiment to be described below, sensor means in use is the sensor section that is disclosed in Patent Document 1 to sense a capacitance to detect a distance to a detection target. The detection target is assumed to be a hand of an operator.

### First Embodiment

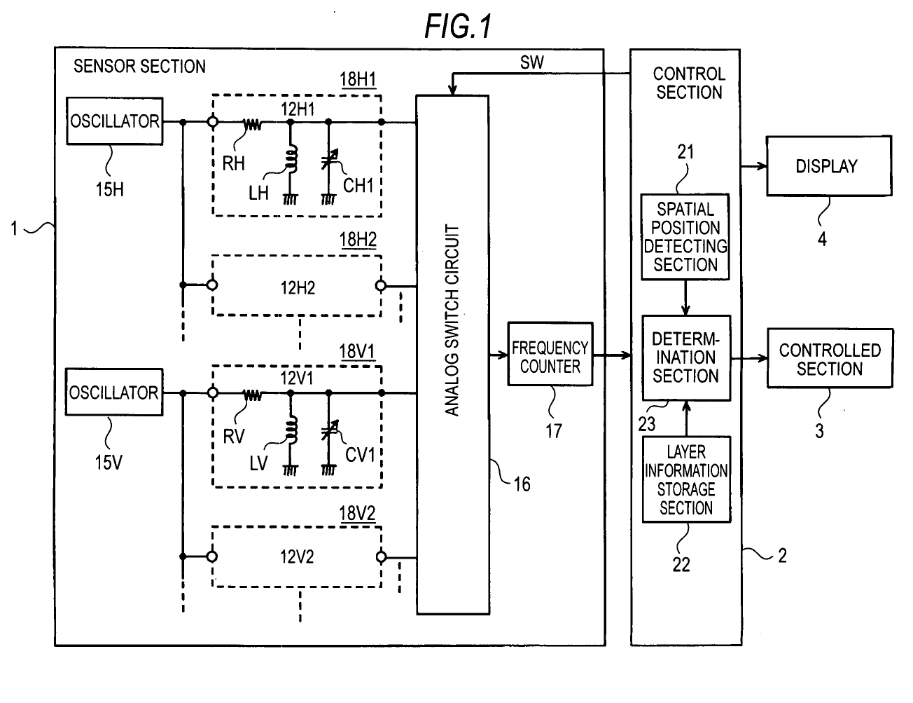

FIG. 1 is a block diagram showing the outline of the general configuration of an information processing apparatus according to a first embodiment. The information processing apparatus according to the first embodiment includes a sensor section 1, a control section 2, a controlled section 3, and a display 4.

The sensor section 1 detects a spatially separated distance of a detection target, and supplies the control section 2 with an output corresponding to the detected distance. As will be described later, according to the embodiment, the sensor section 1 has a rectangular sensor panel with a two-dimensional surface of a predetermined size, and detects a distance to the detection target from the surface of the sensor panel.

According to the embodiment, the sensor section 1 is configured to be able to independently detect distances to a detection target at a plurality of positions in each of the horizontal and vertical directions of the sensor panel surface as detection outputs. Accordingly, the information processing apparatus according to the embodiment can also detect where on the sensor panel surface the detection target is located.

That is, given that the horizontal direction and vertical direction of the sensor panel surface are an x-axial direction and a y-axial direction, respectively, and a direction orthogonal to the sensor panel surface is a z-axial direction, the spatially separated distance of the detection target is detected as the value of the z-axial coordinate. The spatial distance of the detection target on the sensor panel is detected by the values of the x-axial coordinate and the y-axial coordinate.

According to the embodiment, the control section 2 has a microcomputer. Upon reception of a plurality of detection outputs from the section 1, the control section 2 determines the distance of the detection target from the sensor panel surface and where on the sensor panel surface the detection target is located.

Then, the control section 2 performs a process to be described later according to the determination results to determine the behavior of the detection target on the sensor section 1, and controls the controlled section 3 and makes the necessary display on the display 4 according to the determination result.

The controlled section 3 is a DVD player function section. In this example, the DVD player function section constituting the controlled section 3 has functions of fast forward playback (called cue playback) and fast rewind playback (called review playback). Under the control of the control section 2, the functions are changed from one to the other and the playback speed is controlled. According to the embodiment, the controlled section 3 also has an audio playback section whose volume is controlled in response to a control signal from the control section 2.

The display 4 includes, for example, an LCD, and displays the function which is currently executed in the controlled section 3 under the control of the control section 2.

The information processing apparatus according to the embodiment will be described below in detail.

### [Description of Sensor Section According to the Embodiment]

According to the embodiment, as in Patent Document 1, the capacitance according to the distance between the surface of the sensor panel 10 and a detection target is converted to an oscillation frequency of an oscillation circuit, which is to be detected. In the embodiment, the sensor section 1 counts the number of pulses of a pulse signal according to the oscillation frequency, and sets the count value according to the oscillation frequency as a sensor output signal.

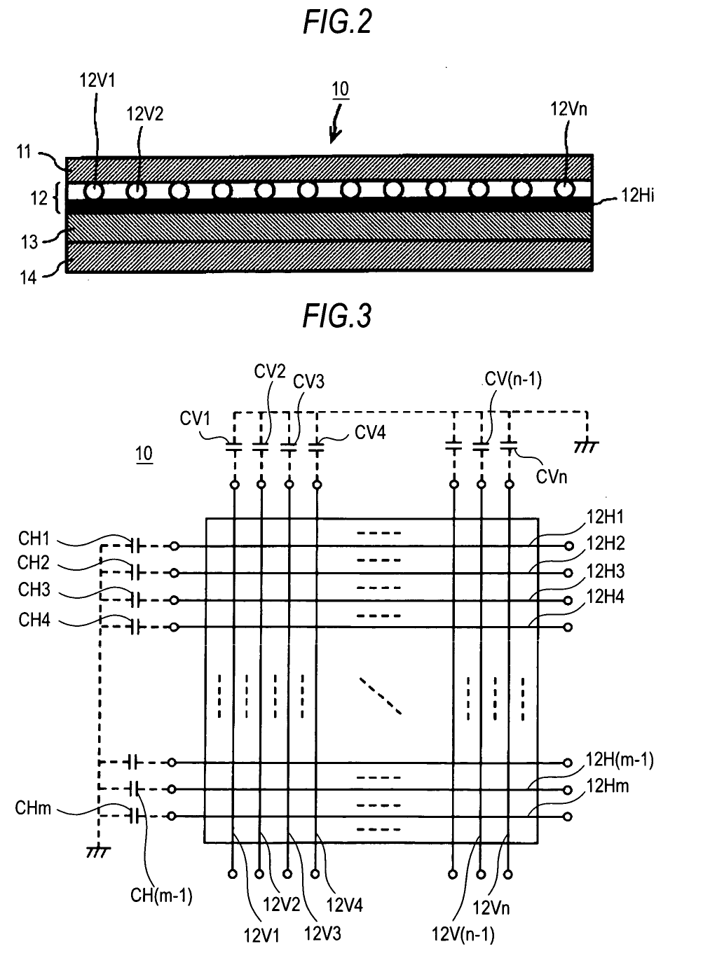

FIG. 1 shows an example of the circuit configuration for generating the sensor output signal as the internal configuration of the sensor section 1. FIGS. 2 and 3 shows an example of the configuration of a sensor panel 10 of the sensor section 1 according to the embodiment. FIG. 2 is a lateral cross-sectional view of the sensor panel 10.

As shown in FIG. 2, an electrode layer 12 is held between two glass plates 11 and 13 in the sensor panel 10 in this example. The sandwich structure having the two glass plates 11, 13 and the electrode layer 12 is adhered onto a substrate 14.

FIG. 3 is a diagram showing the sensor panel 10 from the direction of the glass plate 11 which is removed. According to the embodiment, the electrode layer 12 has a plurality of wire electrodes laid out on the glass plate 13 in two orthogonal directions, as shown in FIG. 3. Specifically, a plurality of horizontal electrodes 12H1, 12H2, 12H3, . . . , 12Hm (m being an integer of 2 or greater) which are wire electrodes whose extending direction is the horizontal direction (lateral direction) in FIG. 3 are arranged in the vertical direction (longitudinal direction) in FIG. 3 at equal pitches, for example.

Capacitances (floating capacitances) CH1, CH2, CH3, . . . , CHm are present between the plurality of horizontal electrodes 12H1, 12H2, 12H3, . . . , 12Hm and the ground. The capacitances CH1, CH2, CH3, . . . , CHm change according to the position of a hand or a finger lying in the space on the surface of the sensor panel 10.

One end and the other end of each of the horizontal electrodes 12H1, 12H2, 12H3, . . . , 12Hm serves as a horizontal electrode terminal. In this example, one of the horizontal electrode terminals of each of the horizontal electrodes 12H1, 12H2, 12H3, . . . , 12Hm is connected to an oscillator 15H for the horizontal electrodes. The other one of the horizontal electrode terminals of each horizontal electrode 12H1, 12H2, 12H3, . . . , 12Hm is connected to an analog switch circuit 16.

In this case, each of the horizontal electrodes 12H1, 12H2, 12H3, . . . , 12Hm can be represented by an equivalent circuit as shown in FIG. 1. While FIG. 1 shows the equivalent circuit of the horizontal electrode 12H1, the same is true of the other horizontal electrodes 12H2, 12H3, . . . , 12Hm.

The equivalent circuit of the horizontal electrode 12H1 includes a resistance RH, an inductance LH, and a capacitance CH1 to be detected. For the other horizontal electrodes 12H2, 12H3, . . . , 12Hm, the capacitance changes from CH1 to CH2, CH3, . . . , CHm.

The equivalent circuit of each of the horizontal electrodes 12H1, 12H2, 12H3, . . . , 12Hm constitutes a resonance circuit, and, together with the oscillator 15H, constitutes an oscillation circuit and serves as a horizontal electrode capacitance detecting circuit 18H1, 18H2, 18H3, . . . , 18Hm. The output of each horizontal electrode capacitance detecting circuit 18H1, 18H2, 18H3, . . . , 18Hm becomes a signal of an oscillation frequency according to the capacitance CH1, CH2, CH3, . . . , CHm corresponding to the distance of the detection target from the surface of the sensor panel 10.

As a user moves the position of a hand or a finger closer to or away from the surface of the sensor panel 10 thereon, the value of the capacitor CH1, CH2, CH3, . . . , CHm changes. Each of the horizontal electrode capacitance detecting circuits 18H1, 18H2, 18H3, . . . , 18Hm, therefore, detects a change in the position of the hand or finger as a change in the oscillation frequency of the oscillation circuit.

In addition, a plurality of vertical electrodes 12V1, 12V2, 12V3, . . . , 12Vn (n being an integer of 2 or greater) which are wire electrodes whose extending direction is the vertical direction (longitudinal direction) in FIG. 3 are arranged in the horizontal direction (lateral direction) in FIG. 3 at equal pitches, for example.

One end and the other end of each of the vertical electrodes 12V1, 12V2, 12V3, . . . , 12Vn serves as a vertical electrode terminal. In this example, one of the vertical electrode terminals of each of the vertical electrodes 12V1, 12V2, 12V3, . . . , 12Vn is connected to an oscillator 15V for the vertical electrodes. In the example, the basic frequency of the output signal of the oscillator 15V for the vertical electrodes is set different from that of the oscillator 15H for the horizontal electrodes.

The other one of the vertical electrode terminals of each vertical electrode 12V1, 12V2, 12V3, . . . , 12Vn is connected to the analog switch circuit 16.

An inter-vertical-electrode capacitance detecting circuit 16V, like an inter-horizontal-electrode capacitance detecting circuit 16H, includes a signal source 161V, a DC bias source 162V, a switch circuit 163V, an inter-electrode equivalent circuit 164V, and a frequency-voltage (FV) converting circuit 165V.

In this case, each of the vertical electrodes 12V1, 12V2, 12V3, . . . , 12Vn can be represented by an equivalent circuit similar to that of the horizontal electrode, as shown in FIG. 1. While FIG. 1 shows the equivalent circuit of the vertical electrode 12V1, the same is true of the other vertical electrodes 12V2, 12V3, . . . , 12Vn.

The equivalent circuit of the vertical electrode 12V1 includes a resistance RV, an inductance LV, and a capacitance CV1 to be detected. For the other vertical electrodes 12V2, 12V3, . . . , 12Vn, the capacitance changes from CV1 to CV2, CV3, . . . , CVn.

The equivalent circuit of each of the vertical electrodes 12V1, 12V2, 12V3, . . . , 12Vn constitutes a resonance circuit, and, together with the oscillator 15V, constitutes an oscillation circuit and serves as a vertical electrode capacitance detecting circuit 18V1, 18V2, 18V3, . . . , 18Vn. The output of each vertical electrode capacitance detecting circuit 18V1, 18V2, 18V3, . . . , 18Vn becomes a signal of an oscillation frequency according to the capacitance CV1, CV2, CV3, . . . , CVn corresponding to the distance of the detection target from the surface of the sensor panel 10.

Each of the vertical electrode capacitance detecting circuits 18V1, 18V2, 18V3, . . . , 18Vn also detects a change in the value of the capacitance CV1, CV2, CV3, . . . , CVn corresponding to a change in the position of the hand or finger as a change in the oscillation frequency of the oscillation circuit.

The output of each horizontal electrode capacitance detecting circuit 18H1, 18H2, 18H3, . . . , 18Hm and the output of each vertical electrode capacitance detecting circuit 18V1, 18V2, 18V3, . . . , 18Vn are supplied to the analog switch circuit 16.

The analog switch circuit 16 sequentially selects and outputs one of the outputs of the horizontal electrode capacitance detecting circuits 18H1 to 18Hm and the vertical electrode capacitance detecting circuits 18V1 to 18Vn at a predetermined speed in response to a switch signal SW from the control section 2.

Then, the output of the analog switch circuit 16 is supplied to a frequency counter 17. The frequency counter 17 counts the oscillation frequency of the signal that is input thereto. That is, the input signal of the frequency counter 17 is a pulse signal according to the oscillation frequency, and the count of the number of pulses in a predetermined time duration of the pulse signal corresponds to the oscillation frequency.

The output count value of the frequency counter 17 is supplied to the control section 2 as a sensor output for the wire electrode that is selected by the analog switch circuit 16. The output count value of the frequency counter 17 is acquired in synchronism with the switch signal SW to be supplied to the analog switch circuit 16 from the control section 2.

Based on the switch signal SW supplied to the analog switch circuit 16, therefore, the control section 2 determines for which wire electrode the output count value of the frequency counter 17 represents the sensor output. Then, the control section 2 stores the output count value in the buffer section of a spatial position detecting section 21 in association with the wire electrode.

The spatial position detecting section 21 of the control section 2 detects the spatial position of a detection target (distance from the surface of the sensor panel 10 and x and y coordinates on the surface of the sensor panel 10) from the sensor outputs for all the wire electrodes to be detected which are stored in the buffer section.

As described in Patent Document 1, the sensor outputs from a plurality of the horizontal electrode capacitance detecting circuits 18H1 to 18Hm and the vertical electrode capacitance detecting circuits 18V1 to 18Vn are actually acquired according to the position of the detection target at the x and y coordinates on the surface of the sensor panel 10. As the distance to the surface of the sensor panel 10 from the position of the detection target at the x and y coordinates on the surface of the sensor panel 10 where the detection target is located becomes the shortest, the sensor outputs from the horizontal electrode capacitance detecting circuit and the vertical electrode capacitance detecting circuit each of which detects a capacitance between two electrodes corresponding to that position become significant as compared with the other sensor outputs.

In view of the above, the spatial position detecting section 21 of the control section 2 acquires the position of the detection target at the x and y coordinates on the surface of the sensor panel 10 where the detection target is located and the distance to the detection target from the surface of the sensor panel 10 both from a plurality of sensor outputs from the sensor section 1. That is, the spatial position detecting section 21 determines that the detection target, e.g., the position of a hand, is located in the space over the position at the detected x and y coordinates. Because the detection target has a predetermined size, it is detected as being separated by a distance corresponding to the capacitance in the range of the position at the x and y coordinates on the sensor panel 10 which corresponds to the size of the detection target.

According to the embodiment, as in the case of Patent Document 1, thinning switching of the wire electrodes to detect a capacitance is carried out according to the distance of the spatially separated position of the detection target to the surface of the sensor panel 10. The thinning switching of the wire electrodes is carried out as the analog switch circuit 16 controls the number of electrodes (including the case of no electrode) disposed between every two electrodes sequential selected, in response to the switch signal SW from the control section 2. The switching timing is determined beforehand according to the distance to the detection target from the surface of the sensor panel 10, and may be a point of a layer change to be described later, for example.

Although an oscillator for the horizontal electrodes and an oscillator for the vertical electrodes are used in the foregoing description, a single common oscillator may be used instead as a simple case. Ideally, oscillators of different frequencies may be provided for the respective wire electrodes.

### [Multiple Layers in the Distance Direction (Z Direction) and Functional Assignment]

According to the embodiment, it is possible to determine the distance of a finger tip of a user from the surface of the sensor panel 10 in the manner described above. When a plurality of layers are set according to different distances from the surface of the sensor panel 10, therefore, the control section 2 can determine on which layer an operator's hand as a detection target lies by means of the sensor section 1.

In consideration of the determination, according to the embodiment, a plurality of layers are set according to different distances from the surface of the sensor panel 10, and the functions of the controlled section 3 are assigned to the respective layers. The control section 2 stores, in a layer information storage section 22, information on the correlation between a plurality of layers and the functions of the controlled section 3 which are assigned to the respective layers.

According to the embodiment, the control section 2 supplies a determination section 23 with information on the distance of the position of the operator's hand from the surface of the sensor panel 10, which is detected from the sensor output from the sensor section 1 in the spatial position detecting section 21. Then, the determination section 23 acquires layer information from the layer information storage section 22, and determines on which one of A plurality of layers the hand or finger tip of the operator is positioned. The determination section 23 of the control section 2 decides that the function assigned to the determined layer has been selected by the user, discriminates the assigned function by referring to the layer information storage section 22, and controls the controlled section 3 for the discriminated function.

The embodiment is configured to be able to also control the attribute value for each function by moving the operator's hand in the z-axial direction.

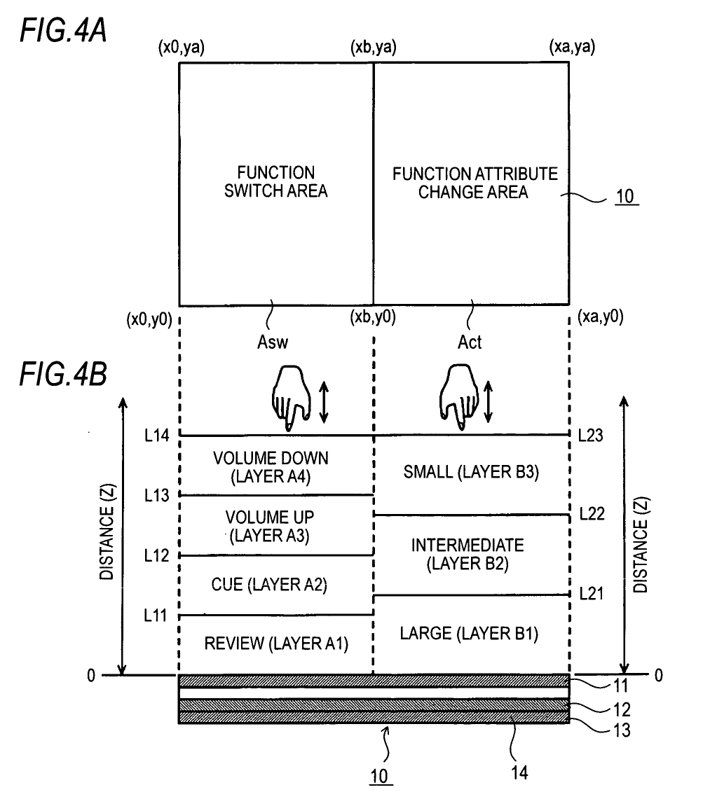

FIGS. 4A and 4B are diagrams showing an example of assignment of a plurality of layers and functions, and a plurality of layers and attribute values thereof for changing the attribute values of the functions.

As shown in FIG. 4A, according to the embodiment, for example, the left-hand side rectangular area of the rectangular area of the sensor panel 10 is set as a function switch area Asw, and the right-hand side rectangular area is set as a function attribute change area Act. The set information is stored in the layer information storage section 22.

Specifically, according to the embodiment, as shown in FIG. 4A, the x and y coordinates (x0, y0) of the lower left corner and the x and y coordinates (xb, ya) of the upper right corner of the function switch area Asw of the sensor panel 10 are stored as function switch area information in the layer information storage section 22. Further, the x and y coordinates (xb, y0) of the lower left corner and the x and y coordinates (xa, ya) of the upper right corner of the function attribute change area Act of the sensor panel 10 are stored as function attribute change area information in the layer information storage section 22.

Because the function switch area and the function attribute change area are rectangular, the x and y coordinates of the lower left corner and the x and y coordinates of the upper right corner are stored information on each area in the layer information storage section 22, which is just one example, the information that specifies such an area is not limited to this type.

According to the embodiment, as mentioned above, the controlled section 3 is configured as a DVD player function section and has the cue playback function and the review playback function. The controlled section 3 has the volume control function.

According to the embodiment, therefore, with regard to the space over the function switch area Asw, four layers A1 to A4 are set according to the distance, as shown in FIG. 4B. In the example shown in FIG. 4B, with the surface position of the sensor panel 10 being set as the origin position 0 of the z axis, the z-directional distances to be the boundaries of the layers A1 to A4 are set to L11, L12, L13 and L14.

Then, the distance ranges of the layers A1 to A4 are set as 0<layer A1≦L11, L11<layer A2≦L12, L12<layer A3≦L13, and L13<layer A4≦L14. Output information of the sensor section 1 which corresponds to the distances L11, L12, L13 and L14 of the layer boundaries is stored in the layer information storage section 22 as threshold values of the layers A1, A2, A3 and A4.

The functions of the controlled section 3 are respectively assigned to the layers A1, A2, A3 and A4, and the assignment results are stored in the layer information storage section 22. In this example, the review playback is assigned to the layer A1, the cue playback is assigned to the layer A2, the volume UP is assigned to the layer A3, and the volume DOWN is assigned to the layer A4.

According to the embodiment, with regard to the space over the function attribute change area Act, three layers B1 to B3 are set according to the distance, as shown in FIG. 4B. In the example shown in FIG. 4B, with the surface position of the sensor panel 10 being set as the origin position 0 of the z axis, the z-directional distances to be the boundaries of the layers B1 to B3 are set to L21, L22 and L23.

Then, the distance ranges of the layers B1 to B3 are set as 0<layer B1≦L21, L21<layer B2≦L22, and L22<layer B3≦L23. Output information of the sensor section 1 which corresponds to the distances L21, L22 and L23 of the layer boundaries may be stored in the layer information storage section 22 as threshold values of the layers B1, B2 and B3.

The attribute values of the function attributes of the individual functions of the controlled section 3 are respectively assigned to the layers B1, B2 and B3, and the assignment results are stored in the layer information storage section 22. In this example, as the attribute values of the function attributes for the review playback and the cue playback, a slow playback speed is assigned to the layer B1, an intermediate playback speed is assigned to the layer B2, and a fast playback speed is assigned to the layer B3. As the attribute values of the function attributes for volume up and volume down, minimum volume change is assigned to the layer B1, intermediate volume change is assigned to the layer B2, and maximum volume change is assigned to the layer B3.

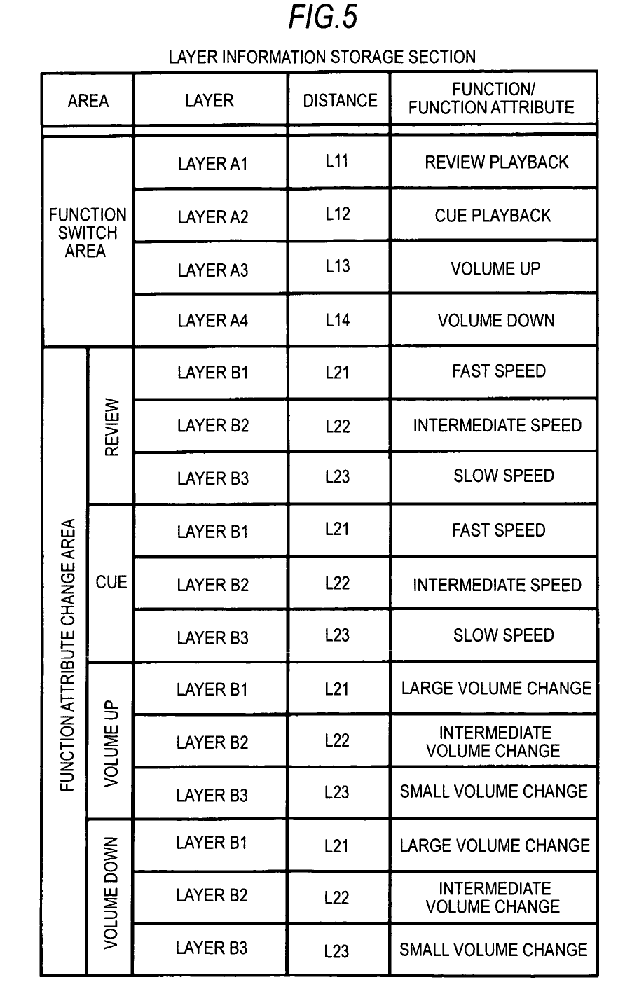

One example of information on the assignment results stored in the layer information storage section 22 is shown in FIG. 5. As mentioned above, for the distance of each layer boundary, output information of the sensor section 1 which corresponds to the distance of that boundary may be stored.

FIG. 5 shows an example of layer information to be stored in the layer information storage section 22 in a table form. The layer information is not limited to the table form, but can take any form as long as it includes information on the same content as that of the information in the example in FIG. 5.

### [Processing Operation of Control Section 2]

In the information processing apparatus according to the first embodiment with the foregoing configuration, the function of the controlled section 3 is selected according to the position of an operator's hand in the space over the surface of the sensor panel 10 (distance from the surface of the sensor panel 10) and behavior of the hand.

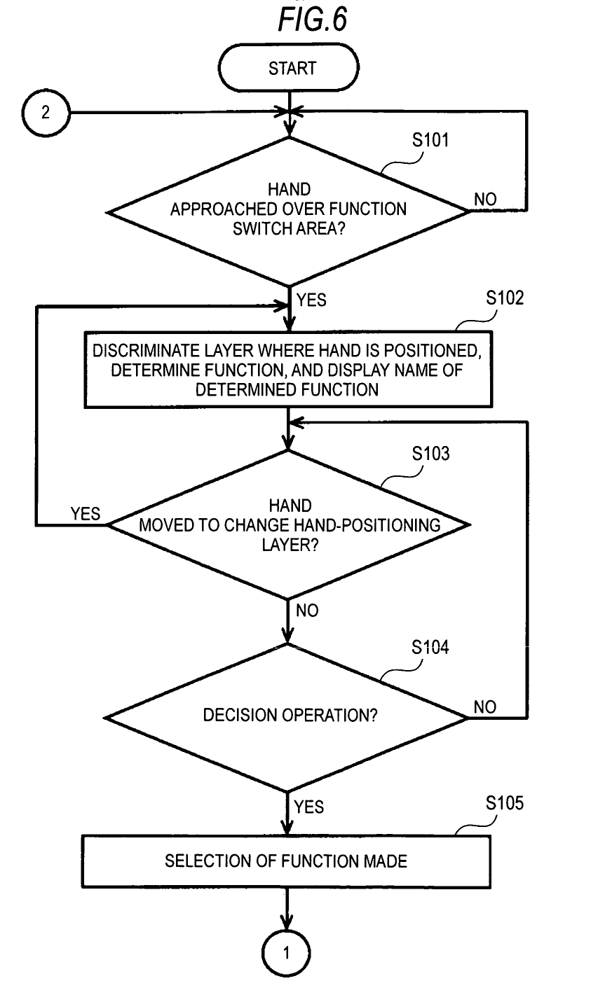

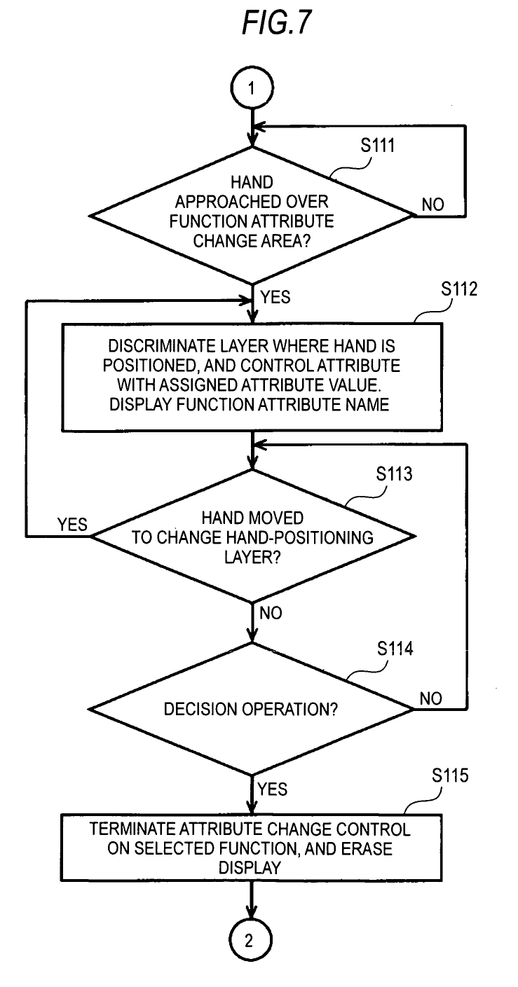

FIGS. 6 and 7 illustrate a flowchart of one example of the processing operation of the control section 2 in the information processing apparatus according to the first embodiment. The processes of the individual steps of the flowchart are executed by the microprocessor in the control section 2 upon reception of the output signal from the sensor section 1.

In this example, it is prioritized to detect an input operation with the operator's hand in the function switch area Asw of the sensor panel 10. In the example, therefore, when an input operation is not made with the operator's hand in the function switch area Asw, an input operation with the operator's hand in the function attribute change area is not detected. However, this is just one example, and detection of an input operation with the operator's hand in the function switch area Asw and detection of an input operation with the operator's hand in the function attribute change area may be carried out in parallel at a time.

In this example, first, the control section 2 monitors the output from the function switch area Asw of the sensor panel 10 of the sensor section 1, and waits for the approach of the operator's hand in the space over the function switch area Asw of the sensor panel 10 (step S101).

When it is determined in step S101 that the operator's hand in the space over the function switch area Asw has approached, the control section 2 discriminates the layer where the hand is positioned to determine the function assigned to the layer. Then, the control section 2 displays the name of the determined function on the display to inform the operator of the function name (step S102). Viewing the function name displayed on the display, the operator can determine whether it is a desired function or not.

In the process of the step S102, the control section 2 first acquires the output signal of the function switch area Asw of the sensor panel 10 of the sensor section 1 to detect the position of the hand, i.e., the distance to the hand from the surface of the sensor panel 10.

Next, the control section 2 compares the detected distance with the boundary distances L11, L12, L13 and L14 of the layers A1, A2, A3 and A4 over the function switch area stored in the layer information storage section 22 to thereby discriminate the layer where the hand is positioned.

Then, the control section 2 refers to the layer information storage section 22 to determine the function assigned to the discriminated layer. Further, the control section 2 reads out display information on the name of the determined function from an incorporated storage section, and supplies the display information to the display 4 to thereby display the function name on the display screen of the display 4.

Next to step S102, the control section 2 monitors the output signal of the function switch area Asw of the sensor panel 10 of the sensor section 1 to discriminate whether or not the operator's hand in the space over the function switch area Asw has moved in the z-axial direction so that the layer where the hand is positioned has been changed (step S103). The discrimination in the step S103 is carried out by comparing the boundary distance (read from the layer information storage section 22) between the upper and lower limits of the distance range of the layer determined in step S102 with the distance determined from the output signal of the sensor section 1.

When it is determined in step S103 that the layer where the hand is positioned has been changed, the control section 2 returns to step S102 to discriminate the changed layer, determine the function assigned thereto in association therewith, and change the function name displayed on the display 4 to the determined function name.

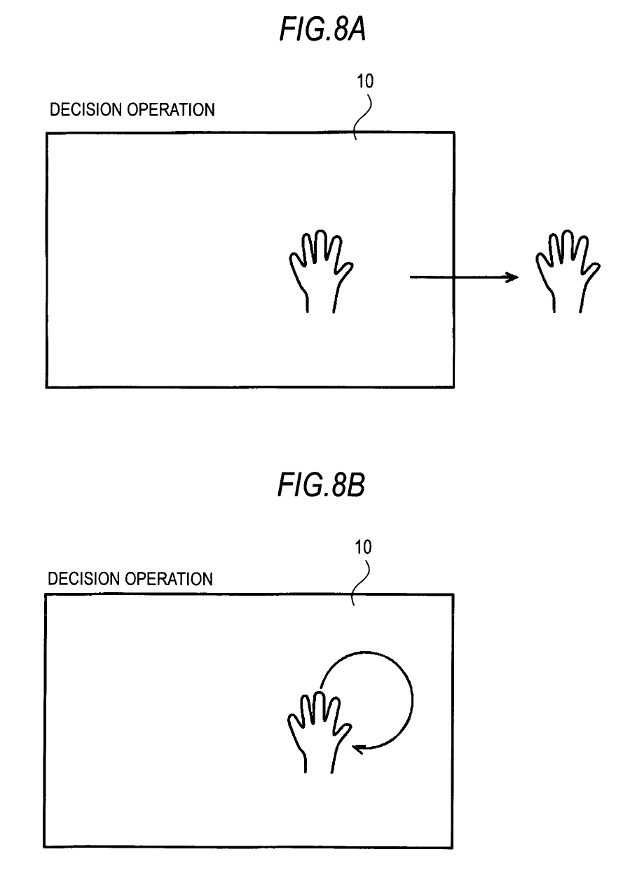

When it is determined in step S103 that the layer where the hand is positioned has not been changed, the control section 2 discriminates whether the operator has made a decision operation or not (step S104). The decision operation is preset as the behavior of the hand within the layer in this example. Examples of the decision operation are shown in FIGS. 8A and 8B.

The example in FIG. 8A shows a decision operation in which the hand present in a layer is horizontally moved out of the sensor panel 10 without being moved to another layer. The control section 2 which monitors the output signal from the sensor section 1 detects the operation as the disappearance of the hand present in one layer without being moved to another layer.

The example in FIG. 8B shows a decision operation which is a predetermined behavior of the hand present in the layer without being moved to another layer, i.e., a predetermined gesture with the hand. In the example in FIG. 8B, a gesture of the hand drawing a circle is the decision operation.

In the example, as mentioned above, the control section 2 can also detect movement of a detection target in the x-axial and y-axial directions of the sensor panel 10 from the output signal of the sensor section 1. There fore, the control section 2 can detect a predetermined horizontal behavior of a hand present in a layer to discriminate whether or not the behavior is a decision operation.

When it is determined in step S104 that a decision operation has not been performed, the control section 2 returns to step S103. When it is determined in step S104 that a decision operation has been performed, however, the control section 2 recognizes that selection of the function under determination has been made (step S105).

Next, the control section 2 monitors the output from the function attribute change area Act of the sensor panel 10 of the sensor section 1, and waits for the approach of the operator's hand in the space over the function attribute change area Act of the sensor panel 10 (step S111).

When it is determined in step S111 that the operator's hand has approached in the space over the function attribute change area Act, the control section 2 discriminates the layer where the hand is positioned, and determine the function attribute assigned to the layer. Then, the control section 2 controls the function of the controlled section 3 according to the determined function attribute. At this time, the control section 2 displays the function attribute name to inform the operator of that name (step S112). Viewing the function attribute name displayed on the display, the operator can determine whether it is a desired function attribute or not.

The processes for the layer discrimination and the function attribute discrimination in step S112 are similar to the processes in step S102 for the function switch area Asw.

Specifically, the control section 2 acquires the output signal of the function attribute change area Act of the .sensor section 1 to detect the position of the hand, i.e., the distance to the hand from the surface of the sensor panel 10. Next, the control section 2 compares the detected distance with the boundary distances L21, L22 and L23 of the layers B1, B2 and B3 over the function attribute change area stored in the layer information storage section 22 to thereby discriminate the layer where the hand is positioned.

Then, the control section 2 refers to the layer information storage section 22 to determine the function attribute assigned to the discriminated layer. The control section 2 then controls the function, selectively set in step S105, according to the determined function attribute. Further, the control section 2 reads out display information on the name of the determined function attribute from the incorporated storage section, and supplies the display information to the display 4 to thereby display the function attribute name on the display screen of the display 4. Alternatively, a symbolic display representing the function attribute such as a bar display for volume UP/volume DOWN and a symbol representing the magnitude of the speed may be displayed in stead of or together with the function attribute name or so that the function name.

Next to step S112, the control section 2 monitors the output signal of the function attribute change area Act of the sensor panel 10 of the sensor section 1 to discriminate whether or not the operator's hand in the space over the function attribute change area Act has moved in the z-axial direction so that the layer where the hand is positioned has been changed (step S113). The discrimination in the step S113 is carried out by comparing the boundary distance (read from the layer information storage section 22) between the upper and lower limits of the distance range of the layer determined in step S112 with the distance determined from the output signal of the sensor section 1.

When it is determined in step S113 that the layer where the hand is positioned has been changed, the control section 2 returns to step S112 to discriminate the changed layer, determine the function attribute assigned thereto in association therewith, and execute function control according to the function attribute. In addition, the control section 2 changes the function attribute name displayed on the display 4 to the determined function attribute name.

When it is determined in step S113 that the layer where the hand is positioned has not been changed, the control section 2 discriminates whether the operator has made a decision operation or not (step S114). In this example, the decision operation is the same as the above-described decision operation in step S104. It is to be noted that the decision operation in step S104 may be the same as the decision operation in step S114, or the decision operations in steps S104 and S114 may be set different from each other in such a way that the operation shown in FIG. 8A is executed in step S104, and the operation shown in FIG. 8B is executed in step S114.

When it is determined in step S114 that a decision operation has not been performed, the control section 2 returns to step S113. When it is determined in step S114 that a decision operation has been performed, the control section 2 discriminates that the decision operation is instruction to terminate the control of the selected function and terminates the attribute change control of the selected function. Further, the control section 2 erases the display of the function name and the function attribute on the display 4 (step S115).

After the step S115, the flow returns to step S101 to repeat a sequence of processes starting at step S101.

### [Specific Operational Example of Controlling Changing of Attribute of Selected Function]

The operator first brings a hand into the space over the function switch area Asw of the sensor panel 10 of the sensor section 1, and moves the hand up or down to select a layer to which a desired function to be selected is assigned while viewing what is displayed on the display 4.

After selecting the layer to which the desired function to be selected is assigned, the operator then performs the above-described decision operation.

Next, the operator brings the hand into the space over the function attribute change area Act of the sensor panel 10 of the sensor section 1, and moves the hand up or down to cause the control section 2 while viewing what is displayed on the display 4 to thereby perform attribute change control on the selected function.

When the selected function is cue playback, for example, slow cue playback is performed with the hand being positioned on the layer B3 in the space over the function attribute change area Act of the sensor panel 10. Shifting the hand position onto the layer B2 can set intermediate cue playback. Shifting the hand position onto the layer B1 can set fast cue playback.

To terminate cue playback, the operator can terminate the cue playback by performing the above-described decision operation. The same is true of review playback.

When the selected function is volume UP, the volume is gradually increased by a small volume change with the hand being positioned on the layer B3 in the space over the function attribute change area Act of the sensor panel 10. Shifting the hand position onto the layer B2 can set the volume change rate to an intermediate rate. Shifting the hand position onto the layer B1 can ensure fast volume control with a large volume change rate.

To terminate the volume UP function, the operator can terminate the volume UP function by performing the above-described decision operation. The same is true of the volume DOWN function.

According to the first embodiment of the invention, as described above, the operator can change the selection of a plurality of functions from one to another and control changing of the attribute value of the selected function without contacting the operation panel.

According to the foregoing first embodiment, after a decision operation is performed over the function switch area Asw, an operational input on the function attribute is made over the function attribute change area Act. Accordingly, the operator can make a sequence of operational inputs over the sensor panel 10 even with a single hand. However, the operator may of course make operational inputs over the function switch area Asw and the function attribute change area Act with the left and right hands, respectively.

Alternatively, the foregoing decision operation may not be performed over the function switch area Asw, and an operational input in the function attribute change area Act may be accepted when a hand remains in a specific layer over the function switch area Asw for a predetermined time or longer. In that case, it is possible to select a layer with, for example, the left hand over the function switch area Asw, and perform attribute value control on the selected function with the right hand. In this case, the selection of the function and attribute value control thereon can be terminated with one of the right and left hands, e.g., the left hand performing the above-described decision operation over the function switch area Asw.

Although control to change the function attribute value is also carried out with the behavior of the operator's hand in the space over the sensor panel 10 according to the first embodiment, the function attribute value changing control may be carried out using a single mechanical operating element, such as a seesaw type button, common to a plurality of functions. That is, in this case, the sensor panel 10 is provided with only the function switch area to execute selective switching of the functions alone, and after selection of a function being set, the above-described volume control and the speed control for the cue playback or review playback can be executed by manipulating the seesaw type button.

Although one sensor panel 10 is separated into the function switch area and the function attribute change area according to the first embodiment, separate sensor panels with different configurations may of course be provided for the function switch area and function attribute change area respectively.

### Second Embodiment

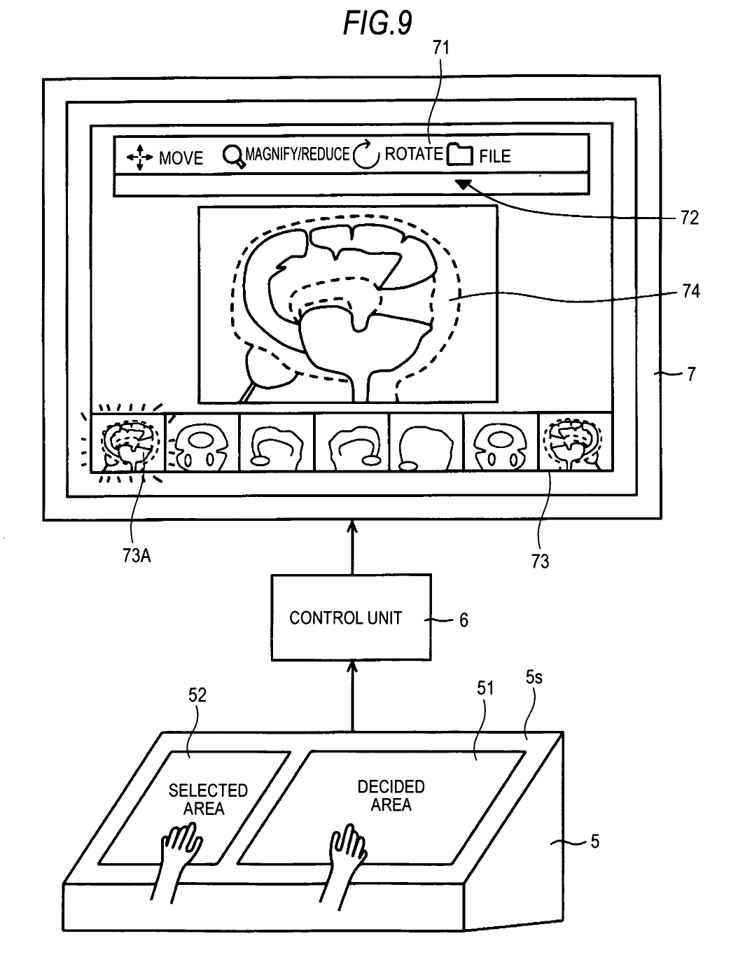

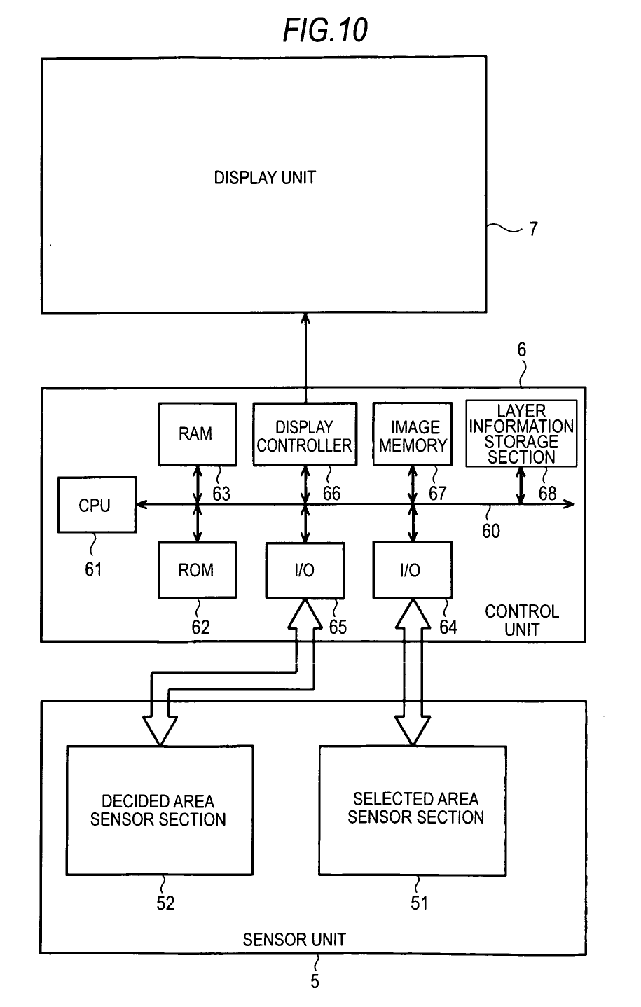

FIGS. 9 and 10 show an example of the configuration of an information processing system according to the second embodiment of the invention, which is adapted to a medical display system called “view box”. Specifically, the information processing system according to the embodiment is designed to display an X-ray photograph, CT image, MRI image or the like on the screen of a display unit 7, and reflects an input operation performed by an operator from a sensor unit 5 on the displayed image in a medical clinic, an operation room or the like.

The information processing system according to the embodiment includes the sensor unit 5, a control unit 6 and the display unit 7. The sensor unit 5 and control unit 6 may be integrated to constitute an information processing apparatus.

The sensor unit 5 has a selected area sensor section 51 and a decided area sensor section 52. Each of the selected area sensor section 51 and decided area sensor section 52 is assumed to have a configuration similar to that of the sensor section 1 in the first embodiment.

Each of the selected area sensor section 51 and decided area sensor section 52 is provided with a sensor panel which has a similar configuration to that of the sensor panel 10 and is in parallel to a flat surface 5s slightly askew to the desk surface when the sensor unit 5 is placed on a desk, for example. The sensor panel is not shown in FIGS. 9 and 10.

According to the embodiment, therefore, the space over the flat surface 5s of the sensor unit 5 becomes an operation input space for the operator. As described in the description of the first embodiment, the input operation is of a non-contact type which is sanitary, and is thus suitable for a medical field.

According to the embodiment, input operations are performed for the selected area sensor section 51 and the decided area sensor section 52 in the sensor unit 5 at a time. According to the embodiment, as will be described later, a predetermined selection input operation is performed for the selected area sensor section 51, and a decision operation for the selection input made with respect to the selected area sensor section 51 is performed for the decided area sensor section 52.

When one person makes an operational input, for example, the selection input operation for the selected area sensor section 51 is carried out with the right hand, and the decision input operation for the decided area sensor section 52 is carried out with the left hand.

It is to be noted that one sensor panel area may be separated into the selected area sensor section 51 and the decided area sensor section 52 as in the first embodiment. In this example, however, the selected area sensor section 51 and decided area sensor section 52 are configured as separate sensor sections.

The control unit 6 is formed by an information processing apparatus including, for example, a personal computer. Specifically, as shown in FIG. 10, the control unit 6 has a program ROM (Read Only Memory) 62 and a work area RAM (Random Access Memory) 63 connected to a CPU 61 (Central Processing Unit) by a system bus 60.

According to the embodiment, I/O ports 64 and 65, a display controller 66, an image memory 67 and a layer information storage section 68 are connected to the system bus 60.

The I/O port 64 is connected to the selected area sensor section 51 of the sensor unit 5 to receive an output signal from the selected area sensor section 51. The I/O port 65 is connected to the decided area sensor section 52 of the sensor unit 5 to receive an output signal from the decided area sensor section 52.

The display controller 66 is connected to the display unit 7 to supply display information from the control unit 6 to the display unit 7. The display unit 7 is configured to use, for example, an LCD as a display device.

The image memory 67 stores an X-ray photograph, CT image, MRI image or the like. The control unit 6 has a function of generating the thumbnail image of an image stored in the image memory 67.

The layer information storage section 68 stores layer information for the selected area sensor section 51 and the decided area sensor section 52 as in the first embodiment. The layer information to be stored in the layer information storage section 68 will be described in detail later.

Upon reception of the output signals from the selected area sensor section 51 and the decided area sensor section 52 of the sensor unit 5, the control unit 6 detects the spatial position of an operator's hand as described in the description of the first embodiment. Then, the control unit 6 determines in which one of a plurality of preset layers the operator's hand is positioned, or the behavior of the hand.

Then, according to the layer and the hand behavior which are determined from the output signals of the sensor unit 5, the control unit 6 reads an image designated by the operator from the incorporated image memory 67, and displays the image on the display unit 7, and performs movement, rotation, and magnification/reduction of the displayed image.

### [Multiple Layers in the Distance Direction (Z Direction) and Assignment of Functions and Function Attributes]

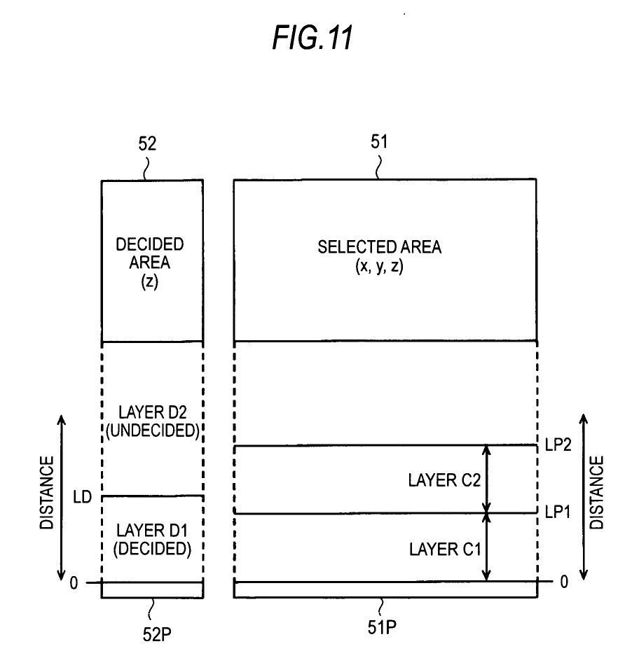

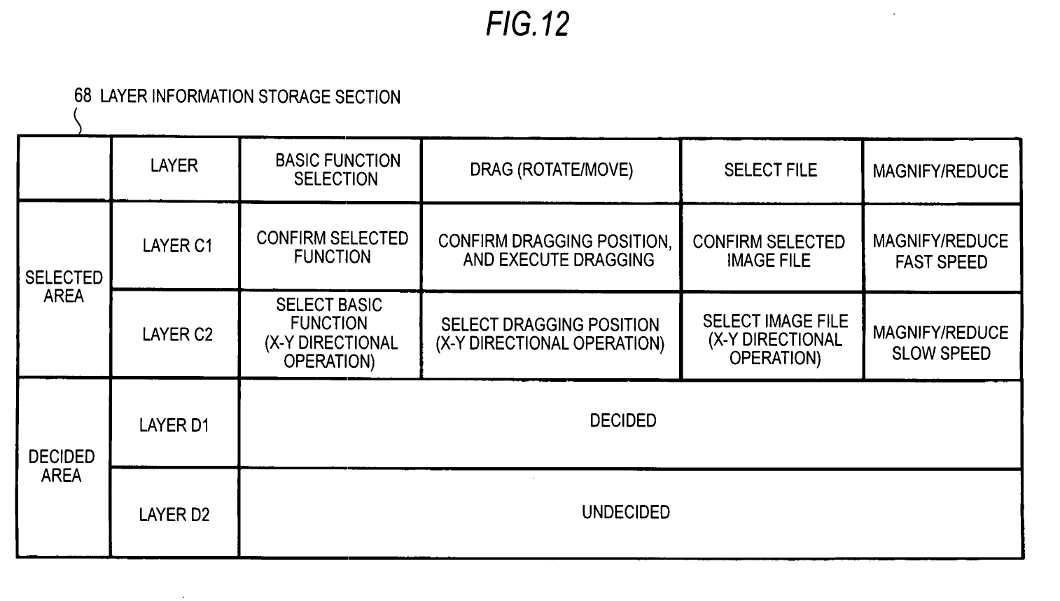

FIG. 11 is a diagram for explaining an example of setting a layer to be set in the space over the selected area sensor section 51 and decided area sensor section 52 of the sensor unit 5 according to the second embodiment. FIG. 12 is a diagram illustrating an example of the storage contents in the layer information storage section 68 of the control unit 6 according to the second embodiment.

According to the second embodiment, two layers C1 and C2 are set in the space over the sensor panel of the selected area sensor section 51 according to the different distances from the sensor panel surface. In this case, as shown in FIG. 11, with the surface position of a sensor panel 51P of the selected area sensor section 51 being set as the origin position 0 of the z axis, the z-directional distances to be the boundaries of the two layers C1 and C2 are set to LP1 and LP2. Therefore, the distance ranges of the layers C1 and C2 are set as 0<layer C1≦LP1 and LP1<layer B2≦LP2.

Two layers D1 and D2 are likewise set in the space over the sensor panel of the decided area sensor section 52 according to the different distances from the sensor panel surface. In this case, as shown in FIG. 11, with the surface position of a sensor panel 52P of the decided area sensor section 52 being set as the origin position 0 of the z axis, the z-directional distances to be the boundaries of the two layers D1 and D2 are set to LD. Therefore, the distance ranges of the layers D1 and D2 are set as 0<layer D1≦LD and LD<layer B2. That is, in the decided area sensor section 52, the distance to the sensor panel 52P is separated into the layer D1 with a smaller distance than the boundary distance LD, and the layer D2 with a larger distance than the boundary distance LD.

According to the embodiment, the layer D2 in the space over the sensor panel 52P of the decided area sensor section 52 means “undecided” when a detection target is present in that layer, and the layer D1 means “decided” when the detection target is present in that layer. That is, as the operator moves the hand from the layer D2 to the layer D1, the motion becomes a decision operation.

As execution of the decision operation in the decided area sensor section 52 is permitted while executing the operation of selecting a function or the like in the selected area sensor section 51, the execution of the operation of selecting a function or the like in the selected area sensor section 51 can be carried out hierarchically according to the second embodiment.

According to the second embodiment, first, a basic function provided in the information processing system according to the embodiment can be selected by the layer selecting operation in the space over the selected area sensor section 51. In the embodiment, selection of a basic function is the operation of the high-rank layer in the selected area sensor section 51. Then, the operation in the low-rank layer in the selected area sensor section 51 is an input operation for the attribute of the function selected at the high-rank layer.

As the basic functions, a drag function, a file selecting function, and a magnification/reduction function are provided in the embodiment.

The drag function designates a part of an image displayed on the display screen, and moves the designated part in parallel or rotates the designated part, thereby moving or rotating the image. According to the embodiment, movement of an image and rotation thereof can be selected as separate functions.

The file selecting function selects an image which the operator wants to display from images stored in the image memory 67.

The magnification/reduction function magnifies or reduces an image displayed on the display screen of the display unit 7.

According to the embodiment, an operation of selecting a basic function is executed in the layer C2 set in the space over the sensor panel 51P of the selected area sensor section 51.

To select a basic function, as shown in FIG. 9, a display bar 71 of basic function icon buttons is displayed on the display screen of the display unit 7. In this example, as shown in FIG. 9, the display bar 71 shows four basic function icon buttons “move”, “magnify/reduce”, “rotate”, and “select file”.

A cursor mark 72 indicating which one of the four basic function icon buttons in the display bar 71, namely “move”, “magnify/reduce”, “rotate”, or “select file” is under selection is displayed in connection with the display bar 71. In the example in FIG. 9, the cursor mark 72 is a triangular mark and indicates that the icon button “select file” is under selection.

With a hand placed on the layer C2, the operator can move the cursor mark 72 to select a desired basic function by moving the hand in the x, y direction within the layer C2.

Moving the hand from the layer C2 to the layer C1 in the high-rank layer of the basic function selection means confirmation of the basic function selected in the layer C2; the icon button of the basic function under selection is highlighted in the embodiment.

When the above-described decision operation is performed in the decided area sensor section 52 with confirmation done based on the highlighted display, the selection of the basic function selected in the layer C2 is set.

According to the embodiment, as apparent from the above, with regard to the high-rank layer of the basic function selection, functions are assigned to the layers C1 and C2 in the space over the sensor panel 51P of the selected area sensor section 51 as shown in FIG. 12. Specifically, a function of selecting a basic function is assigned to the layer C2, and a function of confirming a selected function is assigned to the layer C1.

As mentioned above, the operation in the low-rank layer in the selected area sensor section 51 is an input operation for the attribute of the function selected at the high-rank layer.

When the function selected in the high-rank layer is “select file”, for example, the file selecting function of selecting an image file is assigned to the layer C2 in the low-rank layer of the file selection as shown in FIG. 12.

To select an image file with the file selecting function, a list 73 of the thumbnail images of images stored in the image memory 67 is displayed on the display screen of the display unit 7 as shown in FIG. 9.

Moving the hand from the layer C2 to the layer C1 in the low-rank layer of the file section means confirmation of the image file selected in the layer C2; the thumbnail of the image file under selection is highlighted in the embodiment. The example in FIG. 9 shows that 73A in the thumbnail image list 73 is highlighted.

When the above-described decision operation is performed in the decided area sensor section 52 with confirmation done based on the highlighted display, the image file selected in the layer C2 is read from the image memory 67, and displayed as an image 74 as shown in FIG. 9.

According to the embodiment, as apparent from the above, with regard to the low-rank layer of the file selection, functions are assigned to the layers C1 and C2 in the space over the sensor panel 51P of the selected area sensor section 51 as shown in FIG. 12. Specifically, a file selecting function is assigned to the layer C2, and a function of confirming a selected image file is assigned to the layer C1.

Likewise, with regard to the low-rank layer of movement or rotation dragging, a function of selecting a drag position is assigned to the layer C2, and a function of confirming a dragging position and a drag executing function are assigned to the layer C1.

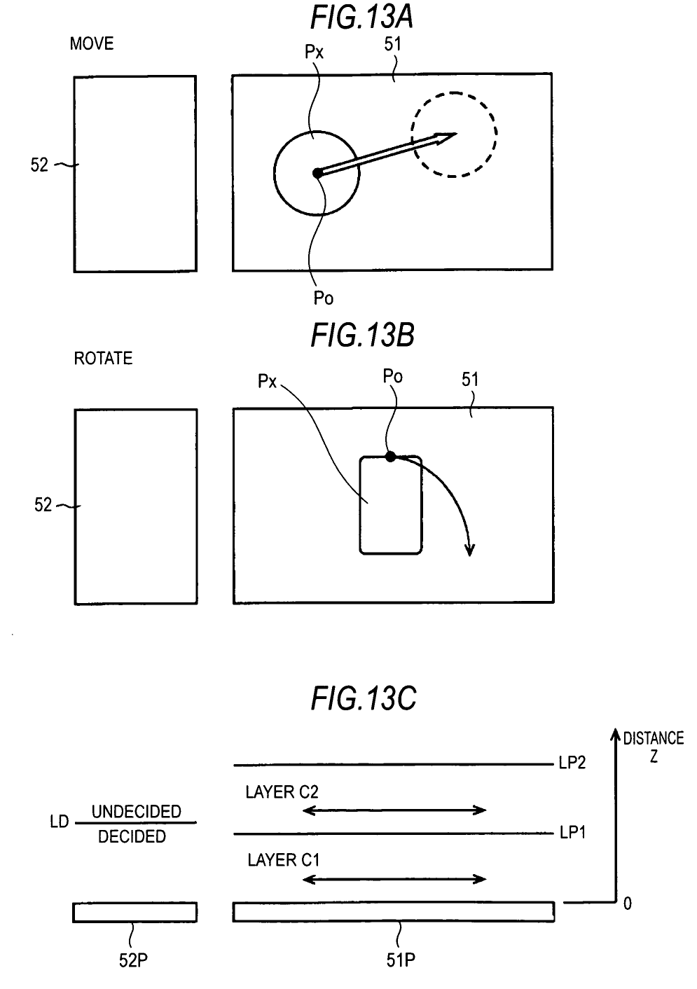

Specifically, when movement dragging is selected in the high-rank layer of the basic function selection, the operator moves the hand in the x, y direction within the layer C2 to designate the position of a part of an image, as shown by arrows in FIG. 13C.

When the operator moves the hand to the layer C1 with a position Po of a part of an image Px being indicated in FIG. 13A or 13B, the indicated position Po is highlighted and the drag function becomes effective in the layer C1. When the operator moves the hand from the position Po horizontally as shown in FIG. 13A, therefore, the control unit 6 executes control to move the image Px in parallel according to the hand movement.

When the above-described decision operation is performed in the decided area sensor section 52 after the moving manipulation, the display position of the image Px is set as it is, and the drag function is terminated.

When the operator rotates the hand from the position Po within the layer C1 as shown in, for example, FIG. 13B, with the indicated position Po being highlighted, the control unit 6 executes control to rotate the image Px.

When the above-described decision operation is performed in the decided area sensor section 52 after the moving manipulation or rotating manipulation, the display position of the image Px is set as it is, and the drag function is terminated.

For the low-rank layer of magnification/reduction, fast magnification/reduction is assigned to the layer C2, and slow magnification/reduction is assigned to the layer C1. That is, for the low-rank layer of magnification/reduction, the speed attributes “magnification/reduction” are assigned to the layers C1 and C2.

When magnification/reduction is selected in the selection of a basic function, whether magnification or reduction is selected according to the x and y coordinate positions of the sensor panel 51P of the selected area sensor section 51 at the layer C1. For example, when the position of the hand at the layer C1 lies in the left-hand area or the upper area of the sensor panel 51P of the selected area sensor section 51, magnification is selected, whereas when the position of the hand at the layer C1 lies in the right-hand area or the lower area of the sensor panel 51P of the selected area sensor section 51, reduction is selected.

### [Processing Operation of Control Unit 6]

In the information processing system according to the second embodiment with the above-described configuration, the control unit 6 executes display control on the display image on the display unit 7 according to the positions of the left hand and right hand of the operator in the space over a surface 5c of the sensor unit 5 (distances from the surfaces of the sensor panel 51P and the sensor panel 52P), and the behaviors of the left hand and right hand.

### <Basic Function Selecting Routine>

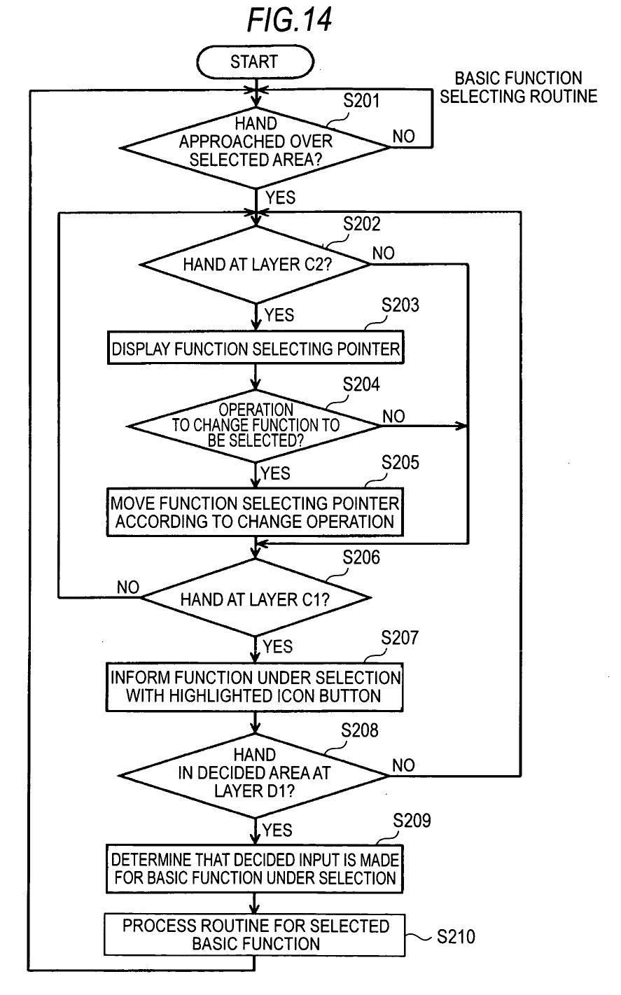

FIG. 14 is a flowchart illustrating one example of the processing operation in response to an operational input at the high-rank layer of the basic function selection in the control unit 6 of the information processing system according to the second embodiment. The CPU 61 of the control unit 6 executes the processes of the individual steps of the flowchart in FIG. 14 according to the program stored in the ROM 62 using the RAM 63 as a work area.

At the time of initiating the basic function selecting routine, the CPU 61 has recognized the functions assigned to the layers C1 and C2, and the layers D1 and D2 in the basic function selection, meanings thereof, and the like by referring to the layer information storage section 68. In other words, the CPU 61 recognizes the basic function assigned to the layer C2 as selection of a basic function, and recognizes that what is assigned to the layer C2 is the function of confirming the selected basic function. In addition, the CPU 61 recognizes the state of a hand present in the layer D1 as a decision operation.

In this example, first, the CPU 61 of the control unit. 6 monitors the output from the selected area sensor section 51 of the sensor unit 5, and waits for the approach of the operator's hand in the space over the sensor panel 51P of the selected area sensor section 51 (step S201).

When it is determined in step S201 that the operator's hand has approached in the space over the sensor panel 51P of the selected area sensor section 51, the CPU 61 discriminates whether the hand is positioned in the layer C2 or not (step S202).

When it is determined in step S202 that the hand is positioned in the layer C2, the CPU 61 performs a process of selecting a basic function, i.e., displays the function selection pointer or the cursor mark 72 on the display screen of the display unit 7 in this example (step S203).

Next, the CPU 61 discriminates whether or not the hand has moved in the x, y direction in the layer C2 as an operation to change a function to be selected (step S204).

When it is discriminated in step S204 that the operation to change the function to be selected is executed, the CPU 61 changes the display position of the function selection pointer or the cursor mark 72 on the display screen of the display unit 7 to a position in the layer C2 according to the change and move operation (step S205).

Next, the CPU 61 discriminates whether or not the hand has moved from the layer C2 to the layer C1 (step S206). When it is discriminated in step S204 that there is not an operation to change the function to be selected, the CPU 61 also moves to step S206 to discriminate whether or not the hand has moved from the layer C2 to the layer C1. Further, when it is discriminated in step S202 that the hand is not positioned in the layer C2, the CPU 61 also moves to step S206 to discriminate whether or not the hand lies in the layer C1.

When it is discriminated in step S206 that the hand does not lie in the layer C1, the CPU 61 returns to step S202 to repeat a sequence of processes starting at step S202.

When it is discriminated in step S206 that the hand lies in the layer C1, on the other hand, the CPU 61 executes a process of confirming the selected basic function. In this example, the CPU 61 highlights the icon button selected in the layer C2 among the basic function icon buttons in the display bar 71 for confirmation (step S207).

Next, the CPU 61 discriminates whether or not the hand over the sensor panel 52P of the decided area sensor section 52 lies in the layer D1 (step S208). When it is discriminated in step S208 that the hand over the sensor panel 52P of the decided area sensor section 52 does not lie in the layer D1, the CPU 61 returns to step S202 to repeat a sequence of processes starting at step S202.

When it is discriminated in step S208 that the hand over the sensor panel 52P of the decided area sensor section 52 lies in the layer D1, however, the CPU 61 determines that a decision operation has been executed for the selected basic function (step S209).

Then, the CPU 61 executes a processing routine for the selected function (step S210). When an operation to terminate the processing routine for the selected function is performed, the CPU 61 returns to step S201 to repeat a sequence of processes starting at step S201.

Next, a description will be given of an example of the processing routine for the selected function in step S210.

### <Processing Routine for Dragging for Movement or Rotation>

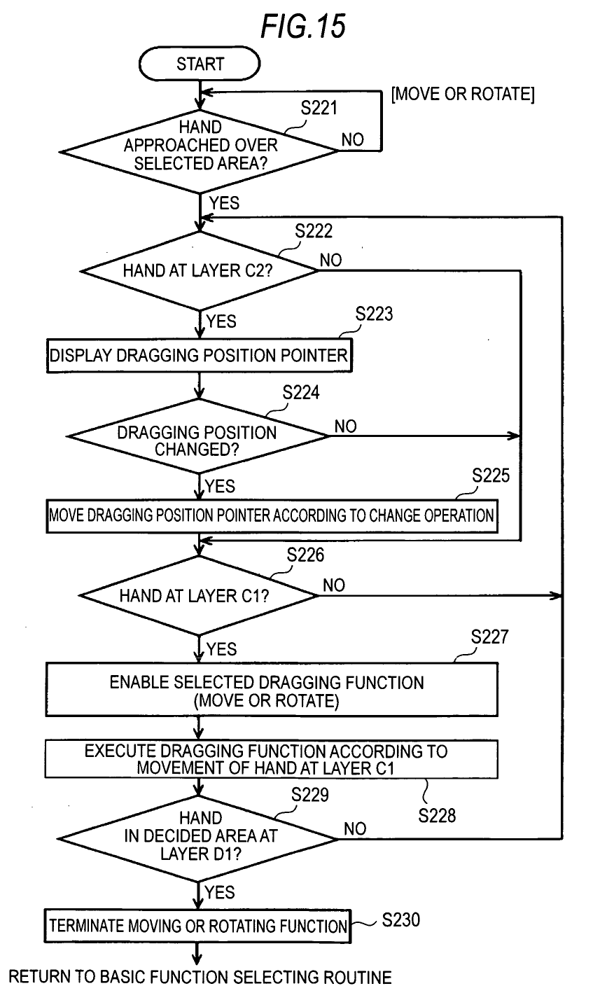

FIG. 15 shows an example of the processing routine in step S210 when the function of dragging for movement or rotation is selected in the basic function selecting processing routine. The CPU 61 of the control unit 6 also executes the processes of the individual steps of the flowchart in FIG. 15 according to the program stored in the ROM 62 using the RAM 63 as a work area.

At the time of initiating the processing routine for the dragging function, the CPU 61 has recognized the functions assigned to the layers C1 and C2, and the layers D1 and D2 in the dragging function, meanings thereof, and the like by referring to the layer information storage section 68. That is, the CPU 61 recognizes the function assigned to the layer C2 as selection of a dragging position, and recognizes the function assigned to the layer C2 as the dragging position confirming and drag executing function. In addition, the CPU 61 recognizes the state of a hand present in the layer D1 as a decision operation or an operation of terminating the dragging function in this case.

First, the CPU 61 of the control unit 6 monitors the output from the selected area sensor section 51 of the sensor unit 5, and waits for the approach of the operator's hand in the space over the sensor panel 51P of the selected area sensor section 51 (step S221).

When it is determined in step S221 that the operator's hand has approached in the space over the sensor panel 51P of the selected area sensor section 51, the CPU 61 discriminates whether the hand is positioned in the layer C2 or not (step S222).

When it is determined in step S222 that the hand is positioned in the layer C2, the CPU 61 performs a process for the dragging position selecting function assigned to the layer C2. In this example, first, the CPU 61 displays a dragging position pointer or a dragging point Po on the display screen of the display unit 7 (step S223). Next, the CPU 61 discriminates whether or not the hand has moved in the x, y direction in the layer C2 to indicate an operation to change the dragging position (step S224).

When it is discriminated in step S224 that the operation to change the dragging position is executed, the CPU 61 changes the display position of the dragging position Po on the display screen of the display unit 7 to a position in the layer C2 according to the change and move operation (step S225).

Next, the CPU 61 discriminates whether or not the hand has moved from the layer C2 to the layer C1 (step S226). When it is discriminated in step S224 that there is not an operation to change the dragging position, the CPU 61 also moves to step S226 to discriminate whether or not the hand has moved from the layer C2 to the layer C1. Further, when it is discriminated in step S222 that the hand is not positioned in the layer C2, the CPU 61 also moves to step S226 to discriminate whether or not the hand lies in the layer C1.

When it is discriminated in step S226 that the hand does not lie in the layer C1, the CPU 61 returns to step S222 to repeat a sequence of processes starting at step S222.

When it is discriminated in step S226 that the hand lies in the layer C1, on the other hand, the CPU 61 enables the dragging function, i.e., the moving or rotating function in this example. Then, the CPU 61 highlights the designated dragging position, and highlights the icon button of either movement or rotation selected in the layer C2 among the basic function icon buttons in the display bar 71 for confirmation (step S227).

Next, the CPU 61 discriminates executes the dragging process corresponding to the movement of the hand in the x, y direction in the layer C1, namely, image movement or image rotation (step S228).

Next, the CPU 61 discriminates whether or not the hand over the sensor panel 52P of the decided area sensor section 52 lies in the layer D1 (step S229). When it is discriminated in step S229 that the hand over the sensor panel 52P of the decided area sensor section 52 does not lie in the layer D1, the CPU 61 returns to step S222 to repeat a sequence of processes starting at step S222.

When it is discriminated in step S229 that the hand over the sensor panel 52P of the decided area sensor section 52 lies in the layer D1, the CPU 61 terminates the dragging function for movement or rotation under execution (step S230). Then, the CPU 61 returns to step S201 in FIG. 14 to resume the basic function selecting processing routine.

### <Processing Routine for File Selection>

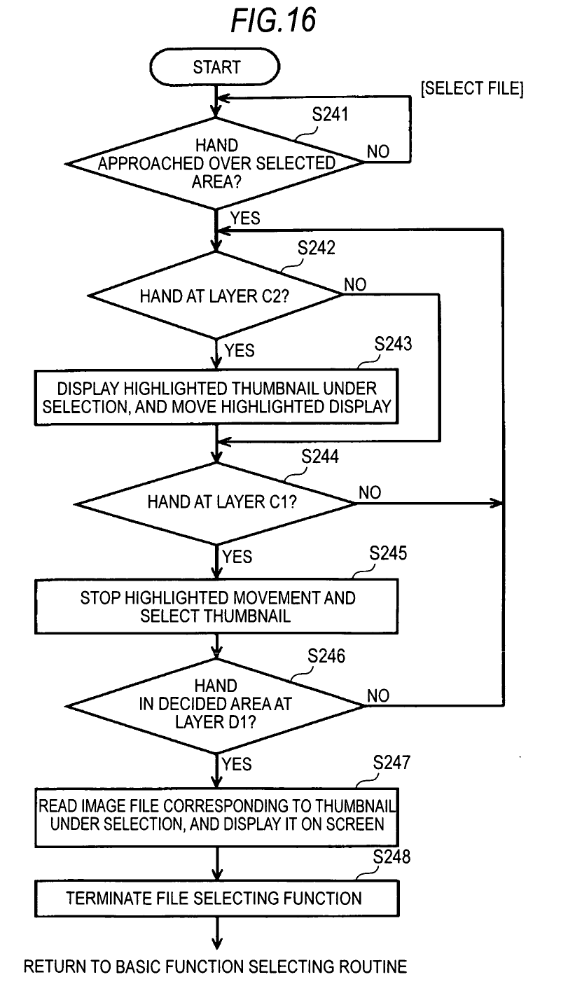

FIG. 16 shows an example of the processing routine in step S210 when the file selecting function is selected in the basic function selecting processing routine. The CPU 61 of the control unit 6 also executes the processes of the individual steps of the flowchart in FIG. 16 according to the program stored in the ROM 62 using the RAM 63 as a work area.

At the time of initiating the processing routine for the file selecting function, the CPU 61 has recognized the functions assigned to the layers C1 and C2, and the layers D1 and D2 in the file selecting function, meanings thereof, and the like by referring to the layer information storage section 68. That is, the CPU 61 recognizes the function assigned to the layer C2 as file selection, and recognizes the function assigned to the layer C2 as the function to confirm the selected file. In addition, the CPU 61 recognizes the state of a hand present in the layer D1 as a decision operation or a file deciding operation in this case.

First, the CPU 61 of the control unit 6 monitors the output from the selected area sensor section 51 of the sensor unit 5, and waits for the approach of the operator's hand in the space over the sensor panel 51P of the selected area sensor section 51 (step S241).

When it is determined in step S221 that the operator's hand has approached in the space over the sensor panel 51P of the selected area sensor section 51, the CPU 61 discriminates whether the hand is positioned in the layer C2 or not (step S242).

When it is determined in step S222 that the hand is positioned in the layer C2, the CPU 61 performs a process for the file selecting function assigned to the layer C2. In this example, the CPU 61 highlights the thumbnail image under selection in the thumbnail image list 73 displayed on the display screen of the display unit 7, and moves the thumbnail image to be highlighted (step S243).

Next, the CPU 61 discriminates whether or not the hand has moved from the layer C2 to the layer C1 (step S244).

When it is discriminated in step S242 that the hand is not positioned in the layer C2, the CPU 61 also moves to step S244 to discriminate whether or not the hand lies in the layer C1.

When it is discriminated in step S244 that the hand does not lie in the layer C1, the CPU 61 returns to step S242 to repeat a sequence of processes starting at step S242.

When it is discriminated in step S244 that the hand lies in the layer C1, on the other hand, the CPU 61 stops moving the thumbnail image to be highlighted, and informs for confirmation that the thumbnail image at the stopped position is selected to be highlighted (step S245).

Next, the CPU 61 discriminates whether or not the hand over the sensor panel 52P of the decided area sensor section 52 lies in the layer D1 (step S246). When it is discriminated in step S246 that the hand over the sensor panel 52P of the decided area sensor section 52 does not lie in the layer D1, the CPU 61 returns to step S242 to repeat a sequence of processes starting at step S242.

When it is discriminated in step S246 that the hand over the sensor panel 52P of the decided area sensor section lies in the layer D1, the CPU 61 determines that the informed thumbnail image under selection is selected. Then, the CPU 61 reads an image corresponding to the selected thumbnail image from the image memory 67, and displays the image as an image 74 on the display screen of the display unit 7 (step S247).

Next, the CPU 61 terminates the processing routine for the file selecting function (step S248), and then returns to step S201 in FIG. 14 to resume the basic function selecting routine.

### <Processing Routine for Magnification/Reduction>

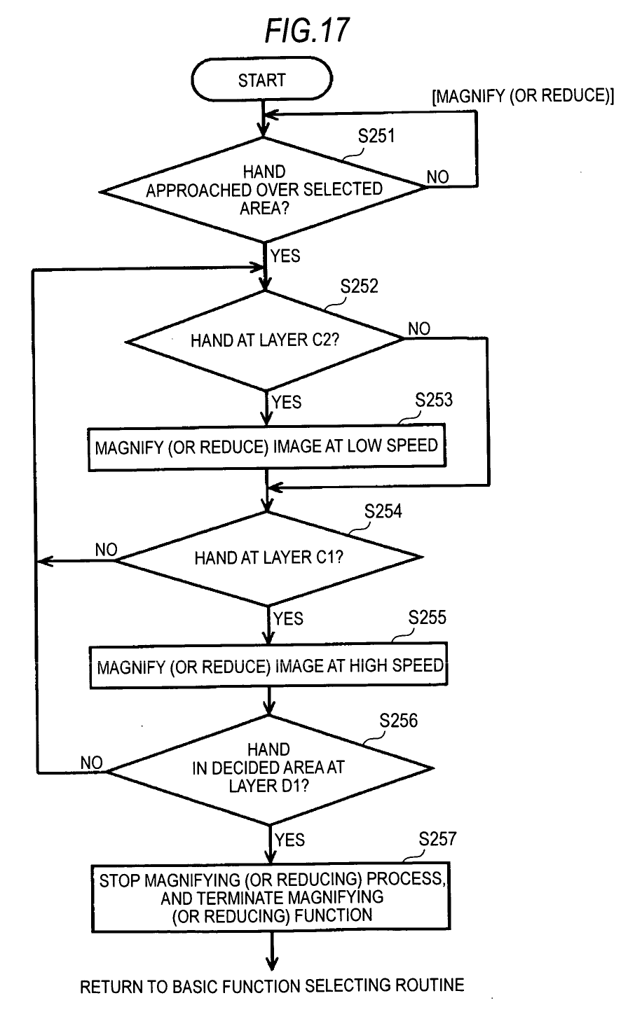

FIG. 17 shows an example of the processing routine in step S210 when the magnification/reduction function is selected in the basic function selecting routine. The CPU 61 of the control unit 6 also executes the processes of the individual steps of the flowchart in FIG. 17 according to the program stored in the ROM 62 using the RAM 63 as a work area.

As described above, in selecting the magnification/reduction function is selected in the basic function selecting routine, either magnification or reduction is selected according to the difference in the selected area in the sensor panel 51P of the selected area sensor section 51, such as the left area and right area, or the upper area and lower area.

At the time of initiating the processing routine for the magnification/reduction function, the CPU 61 has recognized the functions assigned to the layers C1 and C2, and the layers D1 and D2 in the dragging function, meanings thereof, and the like by referring to the layer information storage section 68. That is, the CPU 61 recognizes the function assigned to the layer C2 as slow magnification/reduction process, and recognizes the function assigned to the layer C2 as fast magnification/reduction process. In addition, the CPU 61 recognizes the state of a hand present in the layer D1 as a decision operation or an operation of terminating the magnification/reduction function in this case.

Then, first, the CPU 61 of the control unit 6 monitors the output from the selected area sensor section 51 of the sensor unit 5, and waits for the approach of the operator's hand in the space over the sensor panel 51P of the selected area sensor section 51 (step S251).

When it is determined in step S251 that the operator's hand has approached in the space over the sensor panel 51P of the selected area sensor section 51, the CPU 61 discriminates whether the hand is positioned in the layer C2 or not (step S252).

When it is determined in step S252 that the hand is positioned in the layer C2, the CPU 61 performs a process for the function assigned to the layer C2, namely, slow image magnification or reduction (step S243).

Next, the CPU 61 discriminates whether or not the hand has moved from the layer C2 to the layer C1 (step S254). When it is discriminated in step S252 that the hand is not positioned in the layer C2, the CPU 61 also moves to step S254 to discriminate whether or not the hand lies in the layer C1.

When it is discriminated in step S254 that the hand does not lie in the layer C1, the CPU 61 returns to step S252 to repeat a sequence of processes starting at step S252.

When it is discriminated in step S254 that the hand lies in the layer C1, on the other hand, the CPU 61 performs the function assigned to the layer C2, namely, fast image magnification or reduction (step S255).

Next, the CPU 61 discriminates whether or not the hand over the sensor panel 52P of the decided area sensor section 52 lies in the layer D1 (step S256). When it is discriminated in step S256 that the hand over the sensor panel 52P of the decided area sensor section 52 does not lie in the layer D1, the CPU 61 returns to step S252 to repeat a sequence of processes starting at step S252.

When it is discriminated in step S256 that the hand over the sensor panel 52P of the decided area sensor section 52 lies in the layer D1, the CPU 61 stops image magnification or reduction, and terminates the processing routine for the magnification/reduction function (step S248). Then, the CPU returns to step S201 in FIG. 14 to resume the basic function selecting processing routine.

According to the second embodiment, as described above, the operator can select and execute a plurality of hierarchical functions with a sequence of operations performed on the operation panel in non-contact manner. The second embodiment has a merit that the operation is simple; for example, the operator selects a function by moving, for example, the right hand up and down in the space over the sensor panel 51P of the selected area sensor section 51, and performs a decision operation by moving the left hand up and down in the space over the sensor panel 52P of the decided area sensor section 52.

Although the foregoing description of the second embodiment has been given of the case where a function or a thumbnail under selection is highlighted, which is not restrictive, any notification display which can appeal to a user can of course be employed.

### [Other Embodiments and Modifications]

Although the sensor means converts a capacitance corresponding to a spatial distance to a detection target into an oscillation frequency which is counted by the frequency counter to be output in the foregoing embodiments, the scheme of acquiring the sensor output corresponding to the capacitance is not limited to this type. For example, a frequency-voltage converter may be used to provide an output voltage corresponding to an oscillation frequency as a sensor output as disclosed in Patent Document 1.

In addition, conversion of a capacitance corresponding to a spatial distance to a detection target into a voltage, the so-called charged transfer scheme, may be used instead. Further, the so-called projected capacitor scheme may be used to detect a capacitance corresponding to a spatial distance to a detection target.

Although wire electrodes are used as the electrodes of the sensor means in the foregoing embodiments, point electrodes may be arranged at intersections between the wire electrodes in the horizontal direction and the wire electrodes in the vertical direction. In this case, a capacitance between each point electrode and the ground is detected, so that the wire electrodes in the horizontal direction and the wire electrodes in the vertical direction are sequentially changed electrode by electrode to detect the capacitances. To provide the adequate detection sensitivity according to the distance to be detected, the electrodes to be detected are thinned or some electrodes are skipped according to the distance to be detected as in the case of using wire electrodes.

While the foregoing embodiments employ the sensor means that can detect a spatial distance to a detection target based on the capacitance, which is not restrictive, any sensor means capable of detecting a spatial distance to a detection can be used as well.

The present application contains subject matter related to that disclosed in Japanese Priority Patent Application JP 2008-264221 filed in the Japan Patent Office on Oct. 10, 2008, the entire contents of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus comprising:
sensor means for detecting a distance to a detection target spatially separated therefrom;
storage means for storing information on boundary values of a plurality of layers to which different functions are respectively assigned, and which are set according to different distances;
determination means for determining in which one of the plurality of layers the detection target is positioned, from the boundary values of the plurality of layers in the storage means and an output signal of the sensor means; and
control means for executing a process about the function assigned to that layer where the detection target is positioned, based on a determination result from the determination means.

2. The information processing apparatus according to claim 1, wherein the sensor means has a plurality of electrodes, and a plane containing the plurality of electrodes and a distance to the detection target spatially separated from the plane are detected from a capacitance corresponding to the distance for each of the plurality of electrodes.

3. The information processing apparatus according to claim 1 or 2, wherein the sensor means is capable of detecting position information on a direction of the detection target in the determined layer which intersects a direction of the distance, and
the control means executes the process about the function based on the position information of the detection target.

4. The information processing apparatus according to claim 1 or 2, wherein the sensor means is capable of detecting position information on a direction of the detection target in the determined layer which intersects a direction of the distance, and
the control means detects a predetermined specific moving locus of the detection target in the determined layer as a decision input in controlling the function.

5. The information processing apparatus according to claim 1 or 2, wherein the sensor means is capable of detecting position information on a direction of the detection target in the determined layer which intersects a direction of the distance, and
the control means detects disappearance of the detection target without moving from the determined layer to another layer as a decision input in controlling the function.

6. The information processing apparatus according to claim 1 or 2, further comprising operation input means,
wherein the control means controls alteration of an attribute of the function assigned to the layer where the detection target is positioned, according to an input operation made through the operation input means.

7. The information processing apparatus according to claim 6, wherein the operation input means includes second sensor means for detecting a distance to the detection target spatially separated therefrom, and
the control means controls alteration of the attribute of the function according to the distance to be detected from an output signal of the second sensor means.

8. The information processing apparatus according to claim 1 or 2, further comprising second sensor means for detecting a distance to a second detection target different from the detection target spatially separated,
wherein the control means detects, as a decision input in the function, that the distance to the second detection target to be detected from an output signal from the second sensor means exceeds a set distance.

9. The information processing apparatus according to claim 7 or 8, wherein the sensor means is capable of detecting position information on a direction of the detection target which intersects a direction of the distance, and
the second sensor means is configured by a partial area of the sensor means in a direction intersecting the direction of the distance.

10. An information processing method for an information processing apparatus having sensor means, storage means, determination means and control means, comprising the steps of:
detecting a distance to a detection target spatially separated therefrom by the sensor means;
storing information on boundary values of a plurality of layers to which different functions are respectively assigned, and which are set according to a different distances in a storage section by the storage means;
determining in which one of the plurality of layers the detection target is positioned by the determination means from the boundary values of the plurality of layers in the storage section and an output signal of the sensor means; and
causing the control means to execute a process about the function assigned to that layer where the detection target is positioned, based on a determination result made in the determination step.

11. An information processing system comprising:
a sensor device which detects a distance to a detection target spatially separated therefrom; and
an information processing apparatus which receives an output signal from the sensor device,
wherein the information processing apparatus includes
storage means for storing information on boundary values of a plurality of layers to which different functions are respectively assigned, and which are set according to different distances;
determination means for determining in which one of the plurality of layers the detection target is positioned, from the boundary values of the plurality of layers in the storage means and an output signal of the sensor device; and
control means for executing a process about the function assigned to that layer where the detection target is positioned, based on a determination result from the determination means.

12. An information processing program for allowing a computer equipped in an information processing system that receives a detection output from sensor means detecting a distance to a detection target spatially separated therefrom to function as:
storage means for storing information on boundary values of a plurality of layers to which different functions are respectively assigned, and which are set according to different distances;
determination means for determining in which one of the plurality of layers the detection target is positioned, from the boundary values of the plurality of layers in the storage means and an output signal of the sensor means; and
control means for executing a process about the function assigned to that layer where the detection target is positioned, based on a determination result from the determination means.

13. An information processing apparatus comprising:
a sensor unit configured to detect a distance to a detection target spatially separated therefrom;
a storage unit configured to store information on boundary values of a plurality of layers to which different functions are respectively assigned, and which are set according to different distances;
a determination unit configured to determine in which one of the plurality of layers the detection target is positioned, from the boundary values of the plurality of layers in the storage unit and an output signal of the sensor unit; and
a control unit configured to execute a process about the function assigned to that layer where the detection target is positioned, based on a determination result from the determination unit.
